(19) United States
(12) Patent Application Publication
(10) Pub. No.: US 2003/0059027 A1
(43) Pub. Date: Mar. 27, 2003

(54) Method and communications system for switching of services within a communications network

(76) Inventors: Thomas Plarre, Holzkirchen (DE); Rainer Supplie, Burgau (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/230,392

(22) Filed: Aug. 29, 2002

(30) Foreign Application Priority Data
Aug. 30, 2001 (DE) 10142494.9

(51) Int. Cl. H04M 7/00

(52) U.S. Cl. 379/229

(57) ABSTRACT

When a communications connection has been established within a communications network from an origin agent system, possibly via at least one intermediate agent system, to a target agent system, a decision is made in the target agent system, using a service identifier transmitted with a signaling message when the communications connection was established, whether the service to be switched will be performed in the target agent system or whether the communications connection for performing the service is to be switched back to at least one intermediate agent system or to the origin agent system.

### CLAIM FOR PRIORITY

This application claims priority to Application No. 10142494.9 which was filed in the German language on Aug. 30, 2001.

### TECHNICAL FIELD OF THE INVENTION

The invention relates to a method and a communications system for switching of services, and in particular, where a communications connection is established by an origin agent system to a target agent system within a communications network.

### BACKGROUND OF THE INVENTION

Network operators of present-day communications networks plan to introduce agent systems, i.e., so-called distributed call centers, distributed network-wide. In this connection, network-wide means regional, but also national or international.

Based on the switching systems in use in present-day communications networks, such as Siemens AG's EWSD, for example, the agent systems used have efficient “call distribution systems” for call centers, which implement a multitude of performance and service characteristics, so-called “features” and “services,” as part of automatic call distribution. For example, these call distribution systems undertake a distribution of tasks to the agents or operators, possibly staggered according to time of day or depending on capacity utilization. Furthermore, these call distribution systems support the inclusion of announcement equipment, for example for automatic greetings, for fee announcements or telephone number information, or of so-called automatic store-and-forward equipment, for example for automatic call connection according to telephone number information. Furthermore, external databases can be integrated into the call distribution system via an “applications” server to send a call to a staff employee of the caller or to immediately display to the network operator relevant customer data sets at the appropriate communications terminal based on the caller's telephone number.

The individual agent systems that belong to a network-wide agent system are coupled with one another via connection lines. In addition, the workstations for agents and/or operators, which are connected with each call distribution system of the agent system, are connected with one another network-wide via a packet-based network, IP or X.25, for example. In the case of a network-wide agent system, features and/or services for a calling subscriber are optionally provided in one or more agent systems.

The following scenario is possible here: If a subscriber calls a service access number of an agent system of a network operator, the call is handled in a first agent system, for example. The call is assigned to an agent workstation via the call distribution system of this agent system. If the agent is not able to perform the service requested by the subscriber, or if the calling subscriber requests additional services, the agent can forward the call to another, second agent system via one of the connection lines. This can be continued in such a manner that, in the end, any number of agent systems can be involved in handling the call.

Likewise, forwarding of the call can be carried out via one of the connection lines to a second agent system if no agent suitable for providing the service requested by the calling subscriber is available in the first agent system. In this case, too, several agent systems may be involved in handling a call.

Switching a call that has been forwarded via several agent systems back for handling is possible in the following case, for example: in the last target agent system, the call was forwarded to an automatic announcement unit by the call distribution system. At this point, the automatic announcement unit is not able to further handle the call, and requests that the call distribution system switch it back to an agent. Further handling of the call is preferably supposed to take place by an agent in the current agent system. However, it is desirable that further handling of the call can also be carried out by an agent in one of the other agent systems involved in the call. For this to take place, the agents of all the agent systems involved in the call must have the data connected with the call available to them.

### SUMMARY OF THE INVENTION

The present invention allows switching back a call that has been forwarded via several agent systems to one of the agent systems, if a request to switch back to an agent is received, in a simple and efficient manner, in order to provide services.

In one embodiment of the invention, if a communications connection has been established from an origin agent system, possibly via at least one intermediate agent system, to a target agent system within a communications network, a decision is made in the target agent system, using a service identifier transmitted with a signaling message when the communications connection was established, whether the service to be provided will be performed in the target agent system or whether the communications connection for performing the service is to be switched back to at least one intermediate agent system or to the origin agent system. For this purpose, a method according to the invention and a corresponding communications system according to the invention are provided, which demonstrates suitable means for implementing the method according to the invention.

One advantage of the invention is that using the service identifier, a decision can be made as to which agent is supposed to handle the call. The agent system to which the previously established communications connection is supposed to be switched back is determined by means of an assignment of the agent responsible for handling the call. In this way, decision rules about switching back such communications connections can be implemented in a simple manner. For example, the following rules can be implemented:

If, by selecting a service access number, the call of the calling subscriber can be transferred directly to an agent system in which an agent suitable for the desired service is available, the call should preferably be handled in this agent system. If the service requested by the subscriber using the dialed service access number is a service that overlaps one agent system, the call is either handled in the current agent system or in another agent system involved in the call. In this case, handling of the call should preferably be carried out in the predecessor agent system, with reference to the communications connection that has been established.

One advantage of this procedure is its simplicity and efficiency. The result achieved is that the use of additional connection lines when establishing a switch-back connection in the case of a switch-back can be avoided.

In another embodiment of the invention, it is provided that in the case of a switch-back of the communications connection that has previously been established, release of at least part of the communications connection switched in the target direction, between the target agent system and the agent system to which the communications connection is supposed to be switched back, is initiated by means of a signaling message.

For this purpose, in the signaling of the release process the agent system selected on the basis of the service identifier, because of the switch-back request, is informed by way of a signaling message of a special release reason.

In this way, not only is the use of connection line resources reduced, but also, active connection line resources are released again as a result of the release.

Assigning an identification number to the communications connection that has previously been established is also advantageous. This identification number has data assigned to it that relate to the said communications connection.

It is advantageous if the identification number is transmitted back to at least one intermediate agent system or to the origin agent system via the signaling connection that has previously been established. This procedure with regard to the identification number has the advantage that the data relating to the communications connection that was previously established is now available to every agent of every agent system.

### BRIEF DESCRIPTION OF THE DRAWINGS

An exemplary embodiment of the invention will be explained in greater detail below, making reference to the drawings.

FIG. 1 shows a constellation of two agent systems, coupled with one another as an example according to the invention.

### DETAILED DESCRIPTION OF THE PREFERRED EMBODIMENTS

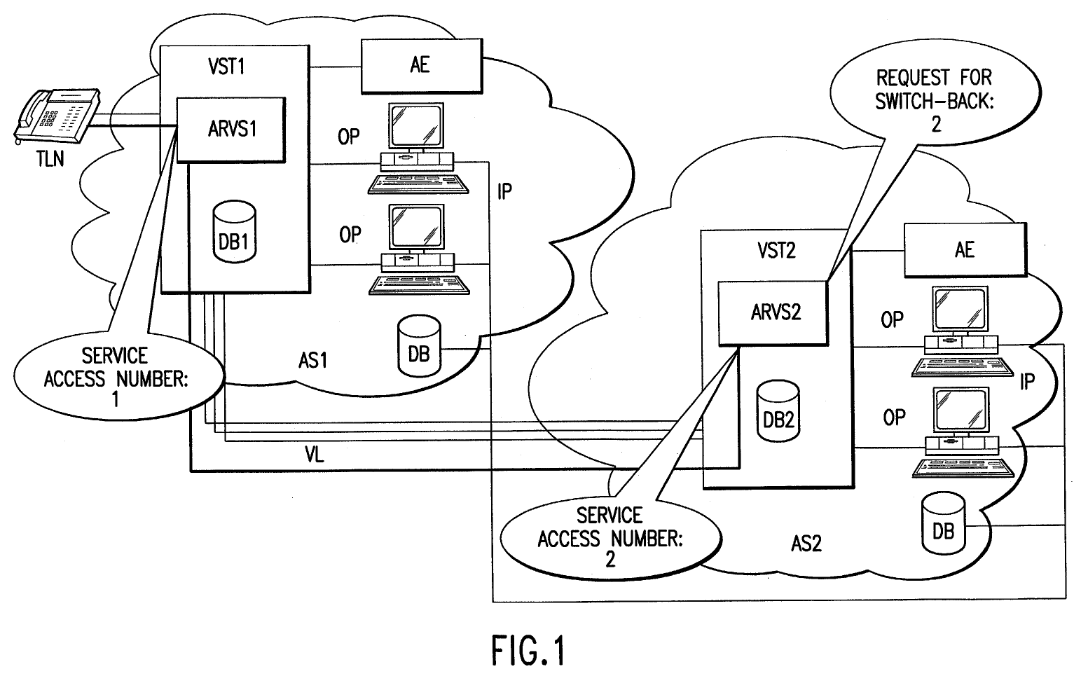

FIG. 1 shows two agent systems, AS1 and AS2, for example, call centers of a network operator, each having the following components:

a switching unit VST1 or VST2, respectively, which comprises a call distribution system ARVS1 or ARVS2, respectively, as well as a database DB1 or DB2, respectively, for call-related and subscriber-related data, respectively,

as well as an automatic unit AE comprising an automatic announcement unit that is coupled with the switching unit VST1 or VST2, respectively.

Furthermore, several agent or operator workstations OP are connected with the switching unit VST1 or VST2, respectively. In addition, subscriber lines are fed to the switching unit VST1 or VST2, respectively, with subscriber terminals being connected by way of these lines, for example as shown in the figure: a telephone TLN to the switching unit VST1.

The agent systems are coupled with one another in the following manner, for example:

1. The switching units VST1 and VST2 are connected with one another via several connection lines VL.

2. The agent workstations OP as well as another database DB are connected with one another via a packet-based network IP, for example the Internet.

The following scenario is possible according to the invention. This is indicated with a heavy line in the figure.

A subscriber, for example a customer of a call center, dials a service access number, for example 1, on his/her subscriber terminal, for example TLN, and thereby reaches the agent system AS1, for example a call center. A service identifier is set for this service access number for handling from an agent switch-back request, as described initially. The service requested by the subscriber cannot be handled in the agent system AS1, for example, because no agent may be available. The subscriber's call is therefore forwarded to a second agent system, for example AS2. The service access number, for example 2, of the second agent system is used for this purpose. The service identifier for handling an agent switch-back request is not set for this service access number. An agent OP of the second agent system AS2 has handled the subscriber's call and possibly forwarded it to an automatic unit for an announcement. When the announcement has ended, there is an agent switch-back request on the part of the automatic unit. The call distribution system ARVS2 of the switching unit VST2 now finds that the agent switch-back request is supposed to be handled in an “backward” agent system, for example VST1. This determination is preferably made according to the following rules:

Service access numbers that can be reached by the subscriber directly, for example service access number 1 for TLN, should be handled in the current agent system. Service access numbers that can be used for services that overlap agent systems and are desired by the subscriber, for example 2, can either be handled in the current agent system or, as in the present case, in an “backward” agent system.

Now the working connection that was previously established between the origin agent system AS1 and the target agent system AS2 is released. For this purpose, a special release reason as well as an unambiguous identification number are passed along with the release-signaling message. The identification number is assigned to the data collected with regard to the call. In this way, this data is available to every agent in every agent system.

The release reason that is passed along is evaluated by a “backward” agent system, for example AS1, and recognized as an agent switch-back request. It is then determined whether the service requested by the subscriber will be handled in this current agent system or whether it is to be forwarded to another “backward” agent system not shown in the figure. Therefore, several agent systems can be involved in handling a service requested by the subscriber. However, the agent switch-back request should be handled no later than in the origin agent system first reached by the subscriber, AS1 in the present example, and the service requested by the subscriber must be performed there.

What is claimed is:

1. A method for switching services, comprising:
establishing a communications connection is by an origin agent system via at least one intermediate agent system to a target agent system within a communications network; and
producing a decision in the target agent system using a service identifier transmitted with a signaling message when the communications connection is established, regardless of whether the service to be provided will be performed in the target agent system or whether the communications connection for performing the service is to be switched back to at least one intermediate agent system or to the origin agent system.

2. The method according to claim 1, wherein in the case of a switch-back of the established communications connection, release is initiated by a signaling message of at least part of the communications connection established between the target agent system and the agent system to which the communications connection is configured to be switched back.

3. The method according to claim 1, wherein an access number is used to establish the communications connection between the origin agent system and the target agent system.

4. The method according to claim 1, wherein the communications connection that has been established is assigned an identification number.

5. The method according to claim 4, wherein data relating to the communications connection that has been established is assigned to the identification number.

6. The method according to claim 4, wherein the assigned identification number is transmitted back to at least one intermediate agent system or to the origin agent system.

7. A communications system for switching services, comprising:
a first device to establish a communications connection between agent systems within a communications network; and
a second device to produce a decision whether a service to be switched can be performed in the target agent system of an existing communications connection, or whether the communications connection for performing the service is to be switched back to an agent system that lies on an existing communications connection path, using a service identifier transmitted with a signaling message.

8. The communications system according to claim 8, further comprising a third device provided to initiate release of at least part of an existing communications connection between the target agent system and the agent system to which the communications connection can be switched back.

9. The communications system according to claim 7, wherein an access number can be used to establish the communications connection.

10. The communications system according to claim 8, wherein an identification number can be assigned to the existing communications connection.

11. The communications system according to claim 10, wherein data relating to the communications connection can be assigned to the identification number.

12. The communications system according to claim 10, the assigned identification number can be transmitted back to the agent system that lies on an existing communications connection path.
